(19) United States
(12) Patent Application Publication
(10) Pub. No.: US 2015/0344369 A1
(43) Pub. Date: Dec. 3, 2015

(54) CONCRETE ADMIXTURE AND PRODUCTION METHOD

(71) Applicant: Construction Research & Technology, GmbH, Trostberg (DE)

(72) Inventors: Jeffrey R. BURY, Auburn Township, OH (US); Joseph Andrew Daczko, Hiram, OH (US); Thomas M. VICKERS Jr., Concord Township, OH (US)

(21) Appl. No.: 14/825,278

(22) Filed: Aug. 13, 2015

(51) Int. Cl. C04B 24/28; C04B 24/26

(52) U.S. Cl. CPC C04B 24/283; C04B 24/2641

(57) ABSTRACT

A method of enhancing efficiency of a batching and/or mixing process for a concrete cementitious composition, includes adding an admixture containing dispersant molecules that bind very rapidly with cement particles and provide a dispersing effect and initial slump during the mixing process, wherein the dispersing effect diminishes rapidly. A multi-component admixture system for cementitious compositions includes: an ultrafast dispersant that binds very rapidly with cement particles, providing a dispersing effect and initial slump, wherein the dispersing effect diminishes rapidly; a general water reducing cement dispersant for providing workability; and, a latent dispersant copolymer having moieties capable of undergoing base-promoted hydrolysis to generate active cement binding sites over time, to extend slump and workability.

Millions of cubic yards (or meters) of concrete are produced globally each year. On the surface, the concept of weighing material, loading a mixer and producing concrete seems simple. However, the vast majority of concrete is produced on an industrial scale, and in practice, the process is more challenging than it appears. This is due to a number of variables that add complexity to the production process, many of which can also impact the batch to batch consistency of concrete performance. Some of these variables include, but are not limited to, batching system type (central batch versus dry batching), mixer type, average daily production volume (and resulting mixing time available), and the variety of mixture types produced daily.

Developing strategies for improving the efficiency of capital equipment used during concrete production, such as concrete batch plants and mixer trucks, is a continuous process for many concrete producers. The ultimate goal however is to achieve operational efficiency while at the same time improving the overall batch to batch quality and consistency of concrete properties.

The following steps outline the typical process associated with batching, mixing, and transporting a production load of concrete;

Step 1—All materials are measured (by mass or volumetrically) in preparation for loading and mixing

Step 2—The materials are discharged into the concrete mixer in the appropriate sequence. If a dry batch system is used, all materials are loaded into the mixer truck.

Step 3A—The materials are mixed at a set speed for a certain amount of time or for the minimum number of revolutions required. Step 3B—If the system is a “wet” batching system (also referred to as a central batch system), the concrete is discharged from the central mixer into the delivery vehicle.

Step 4—In some ready-mixed concrete production facilities, prior to leaving the yard, the truck driver will stop at a rinsing station (sometimes referred to as the “slump rack”) and wash excess material off of the truck that came from the discharge/batching operation. The driver may also be required to test or visually assess the slump level of his batch of concrete at this time.

Step 5—The delivery vehicle travels to the jobsite or discharge location. This can take shorter or longer amounts of time depending on distance, traffic, speed limit, and the like.

Step 6A—Once at the job site, the load is examined to ensure it has the correct concrete consistency, either via testing or visually, depending on the project specification.

Step 6B—If necessary, the workability of the load is adjusted through the addition of water or an admixture. In these cases additional mixing time is also required.

Step 7—The transport vehicle is positioned into the correct discharge location.

Step 8—The concrete is discharged from the delivery vehicle.

Step 9—The delivery vehicle is washed down.

Step 10—The delivery vehicle returns to the concrete batch plant.

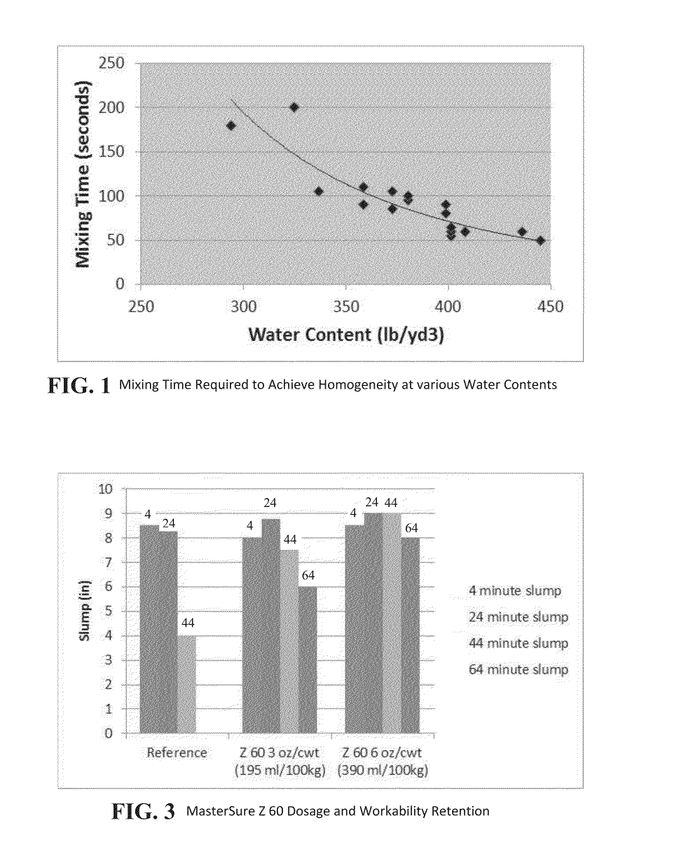

FIG. 1 is a graphical representation of the mixing time required to achieve homogeneity in a concrete cementitious mixture at various water contents.

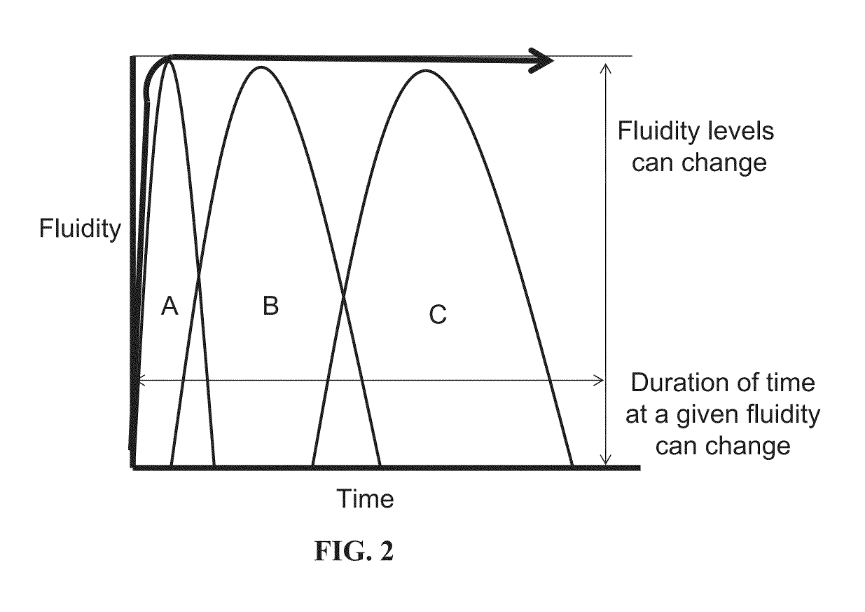

FIG. 2 is a graphical representation of the control of concrete cementitious mixture fluidity from mixing process to final placement achievable by the use of the subject multicomponent admixture.

FIG. 3 is a graphical representation of the workability retention achieved over conventional dispersants using an added slump retention copolymer.

The need to efficiently mix and discharge concrete from a central mixer is an important metric for concrete producers, whether for ready-mix, manufactured concrete products (MCP), paving, durable sprayed concrete, or precast concrete. For example, precast concrete producers typically mix for 60-120 seconds. When a concrete mixture is low in water, mixing efficiency or time required to achieve a homogeneous, workable consistency is negatively impacted. FIG. 1 shows the “stabilization time”, which is defined as the time it takes for a mixture to become “homogeneous” in a mixer, versus mixture water content. The stabilization time that is needed for a mixture to become homogeneous in a mixer can increase 3-fold or more as the mixture water content decreases.

The current trend in concrete mixture proportioning is performance oriented, coupled with sustainability. Sustainable concrete mixtures typically substitute other powders for some portion of the Portland cement. This then requires a reduction in water content to achieve the desired hardened properties. For example, high performance Green Sense® concrete mixtures use very high proportions of supplementary cementing materials (SCM's) and a very low quantity of water. In some commercial applications, this may result in more than 5 minute mix times in a Ready Mix central mixer, using current cement workability admixtures. In a precast plant, this lengthening of mixing time leads to longer overall casting times, and in a ready mix plant, can lead to trucks backing up at the central mixer on high volume days. Currently producers rely on their normal, mid or high range water reducer to achieve initial dispersion during mixing, and they mix longer or increase dosage.

The hydraulic cement used to make the concrete cementitious composition can be a portland cement, a calcium aluminate cement, a magnesium phosphate cement, a magnesium potassium phosphate cement, a calcium sulfoaluminate cement, pozzolanic cement, slag cement, or any other suitable hydraulic binder. Aggregate may be included in the concrete cementitious composition. The aggregate can be silica, quartz, sand, crushed marble, glass spheres, granite, limestone, calcite, feldspar, alluvial sands, any other durable aggregate, and mixtures thereof.

Over the years, the use of fillers and/or pozzolanic materials as a partial replacement for portland cement in concrete has become an increasingly attractive alternative to portland cement alone. The desire to increase the use of inert fillers and/or fly ash, blast furnace slag, and natural pozzolanic cement in concrete mixtures can be attributed to several factors. These include cement shortages, economic advantages of portland cement replacement, sustainability, improvements in permeability of the concrete product, and lower heats of hydration.

The concrete cementitious compositions described herein may contain other additives or ingredients and should not be limited to the stated or exemplified formulations. Cement additives that can be added independently include, but are not limited to: air entrainers, freeze-thaw resistance admixtures, aggregates, pozzolans, other fillers, set and strength accelerators/enhancers, set retarders, water reducers, corrosion inhibitors, wetting agents, water soluble polymers, rheology modifying agents, water repellents, fibers, dampproofing admixtures, permeability reducers, pumping aids, fungicidal admixtures, germicidal admixtures, insecticide admixtures, finely divided mineral admixtures, alkali-reactivity reducer, bonding admixtures, shrinkage reducing admixtures, and any other admixture or additive that does not adversely affect the properties of the cementitious composition. The concrete cementitious compositions need not contain one of each of the foregoing additives.

As used herein, the term “ready mix” refers to cementitious composition that is batch mixed or “batched” for delivery from a central plant instead of being mixed on a job site. Typically, ready mix concrete is tailor-made according to the specifics of a particular construction project and delivered ideally in the required workability in “ready mix concrete trucks”.

The term “precast” cementitious compositions or precast concrete refers to a manufacturing process in which a hydraulic cementitious binder, such as Portland cement, and aggregates, such as fine and course aggregate, are placed into a mold and removed after curing, such that the unit is manufactured before delivery to a construction site. Precast applications include, but are not limited to, precast cementitious members or parts such as beams, double-Ts, pipes, insulated walls, prestressed concrete products, and other products where the cementitious composition is poured directly into forms and final parts are transported to job sites.

Provided is a method and mixing efficiency admixture to improve the overall efficiency of concrete production, and the consistency of concrete performance. This result is accomplished, in part, by strategically targeting particular steps during the batching, mixing and delivery process that include the potential for time delays or the introduction of performance variability.

In a high volume production environment, the efficiency of the batching and mixing equipment invariably is determined by the volume of material produced per unit of time. In some instances this desired efficiency can be at odds with the desire for consistent performing concrete. This is especially true as the required concrete performance goes from lower to higher levels. FIG. 1 shows the relationship between the duration of mixing time required to achieve full mixing and homogeneous distribution of materials as measured by a consistent amp meter reading, representative of mixture workability and mixer energy required during mixing, and the water content of a concrete mixture.

Although each set of raw materials, mixers, and associated equipment may have its own unique time versus water content relationship, all other things being equal, as the water content of a concrete or cementitious mixture decreases, the mixing time required to achieve homogeneous fresh properties will increase. In a situation where a variety of mixtures, with variable water contents are being produced, the potential for inconsistent performance exists. This is particularly true if the batch plant operator does not recognize this water content mixing time relationship. It is possible that he/she will make adjustments to the batch of concrete during the mixing cycle in order to achieve a certain amp meter reading within a maximum mixing time. Those adjustments would likely be either water or admixture addition which can influence the slump, air content and compressive strength of the concrete mixture.

Slump is a measure of the consistency of concrete, and is a simple means of ensuring uniformity of concrete on-site. To determine slump, a standard size slump cone is filled with fresh concrete. The cone is then removed, and the “slump” is the measured difference between the height of the cone and the collapsed concrete immediately after removal of the slump cone.

The slump of the cementitious compositions can be determined by placing a cone on a flat surface, filling the cone with the cementitious composition, and removing the cone, as described in ASTM C143. The composition will then flow, and the displaced height (slump) of the resulting mound of the cementitious composition, as well as the diameter (slump flow) of the base of the mound, are measured in inches or in centimeters.

Provided is a method of enhancing efficiency of a batching and/or mixing process for a concrete cementitious composition, comprising adding to the cementitious composition prior to or during the batching and/or mixing process, an admixture comprising dispersant molecules having an ionic moiety or multiple ionic moieties that bind very rapidly with cement particles, and optionally one or more nonionic dispersing moiety(ies), that provide a dispersing effect and initial slump during the mixing process, wherein the dispersing effect of the admixture diminishes rapidly.

Also provided is a multi-component admixture system comprising:

a) at least one ultrafast dispersant having an ionic moiety or multiple ionic moieties that bind very rapidly with cement particles, that provide a dispersing effect and initial slump to a concrete cementitious composition optionally during mixing, wherein the dispersing effect diminishes rapidly;

b) at least one general water reducing cement dispersant for providing workability to the cementious composition,

c) at least one latent dispersant copolymer having moieties capable of undergoing base-promoted hydrolysis in the cementitious composition to generate active cement binding sites over time, to extend slump and workability of the cementitious composition.

Also provided is a concrete production method for controlling consistency of a concrete cementitious mixture from batching to placement comprising adding to the cementitious mixture:

a) prior to or during the batching and/or mixing process, an ultrafast dispersant admixture comprising dispersant molecules having an ionic moiety or multiple ionic moieties that bind very rapidly with cement particles, and optionally one or more nonionic dispersing moiety(ies), that provide a dispersing effect and initial slump during the mixing process, wherein the dispersing effect of the admixture diminishes rapidly;

b) optionally at least one general water reducing cement dispersant for providing workability to the cementious mixture; and

c) optionally at least one latent dispersant copolymer having moieties capable of undergoing base-promoted hydrolysis in the cementitious mixture to generate active cement binding sites over time, to extend slump and workability of the cementitious mixture.

The subject batching and mixing efficiency admixture and methods provide concrete producers with the ability to more efficiently and consistently produce high performance concrete.

The batching and mixing efficiency admixture provides very rapid initial dispersion and slump generation. This relieves the concrete batch plant operator from the worry of making water or admixture additions, or the need to adjust the mixing time, in order to achieve homogeneity in the production batch.

The subject batching and mixing efficiency method also provides consistency in its slump generation across mix designs and cements.

The subject batching and mixing efficiency admixture comprises certain dispersant structures that may be added separately to a concrete mixture and that very rapidly bind with the cement, quickly disperse the cement during the desired short mixing period, and then wear off (lose their dispersing effect), also within a very short time, such as a matter of minutes. These ultra-fast dispersants may be used as admixtures specifically incorporated to enhance the batching and mixing efficiency of high performance and sustainable concrete mixtures, and may result in more “consistent concrete” in terms of air and slump generation at the plant.

The subject batching and mixing efficiency admixture comprise dispersant molecules having an ionic moiety or multiple ionic moieties that bind very rapidly with cement particles, and optionally one or more nonionic dispersing moiety(ies), that provide the desired initial slump during the mixing process. Typically, binding is triggered as soon as the dispersant molecules come into contact with the cement, or cement and SCM, particles in the presence of water.

In certain embodiments, the batching and mixing efficiency admixture dispersant comprises a (co)polymer. These polymer(s) intentionally lose workability at a very fast rate. The dispersing effect of the admixture diminishes within about 20 minutes, optionally within about 10 minutes or further optionally within about 5 minutes, of achieving a homogeneous mixture. This is in general contrast to the desired performance characteristics of current dispersants, such as polycarboxylate ether (PCE) type dispersants, where relatively longer workability retention is the desired characteristic. Causes of the loss of cementitious mixture workability include but are not limited to a reduction in dispersant surface coverage (density) on particle surfaces due to cement hydration, consumption of the added dispersant, and/or mixing/shearing action that creates new surfaces on the cement or SCM particles.

The use of such ultra-fast batching and mixing efficiency admixture dispersants, and their planned rapid loss of workability during or shortly after mixing, allows current production and handling practices to still be used in forming or extruding low workability concrete articles. However, due to the improved dispersion and workability of the concrete cementitious composition during the initial mixing, additions or modifications to mixture components or composition may be made which result in improved hardened properties. Further, the use of such ultra-fast batching and mixing efficiency admixture dispersants, and their planned rapid loss of workability during or shortly after mixing, makes it easier to entrain air in the concrete cementitious mixtures, and shortens the mixing time needed to obtain a homogeneous cementitious mixture regardless of the intended application.

One embodiment of the subject method comprises a process improvement in the production of cementitious mixtures having low water content and/or low workability characteristics. Certain embodiments of the subject method comprise the production of ultra-high performance mixtures with low water-binder ratios at or below 0.30, and/or cementitious compositions with low workability characteristics such as paving concrete or manufactured concrete products (MCP).

Illustrative examples of the batching and mixing efficiency admixture dispersant include but are not limited to the following.

The mixing efficiency admixture, or ultrafast dispersant, in one embodiment, may be an extremely fast binding polycarboxylate type molecule, with a high ratio of anionic binding residues to (poly)ether side chain terminated residues, such as greater than or equal to about 10:1, greater than or equal to about 7:1, greater than or equal to about 5:1, or greater than or equal to 3:1. The carboxylic acid residues may be acrylic, (meth)acrylic, maleic, mixtures thereof, and the like. The polyether side chain may be from 1 to about 450, or from 1 to about 130, or from 1 to about 250 oxyalkylene units (C₂-C₄ oxyalkylene, such as EO, PO, or the like) in length, and may comprise an alkenyl ether (such as a vinyl ether) residue or carboxylic acid ester residue, among others. Illustrative examples of extremely fast acting polycarboxylate type compounds are sold by BASF under the trademark Melflux®.

In another embodiment, the mixing efficiency admixture, or ultrafast dispersant may be a homopolymer or copolymer of acrylic acid, methacrylic acid, maleic acid, mixtures thereof, or the like. The copolymer may contain residues of other units not having a polyether side chain, such as acrylic acid ester or maleic acid ester, and may be sulfated or sulfonated and/or phosphated or phosphonated.

Certain of these dispersants can wet-out a cementitious mixture in about 60 seconds, yet may lose their effectiveness in 2 to 20 minutes or 2 to 10 minutes, in some instances in 2 to 3 minutes. While certain of these dispersants have been known for other uses, they were previously considered unsuitable for use in concrete cementitious mixtures, because of their extremely short-lived effectiveness for providing workability to cementitious compositions.

A multi-component workability admixture system is also provided, capable of improving mixing, production efficiency and hardened properties of cementitious mixtures.

In one aspect, the batching and mixing efficiency admixture comprises part of a multi-component workability admixture system where it is used in combination with existing general water reducers, and slump retaining admixtures such as MasterSure® Z-60 admixture. The levels of each component of this three component system may be tailored to achieve virtually any level of concrete plastic property for a wide range of materials and mixture proportions; increasing or maintaining fast, efficient production throughput (using the subject batching and mixing efficiency admixture), providing desired workability and good strength performance (using a mid or high range water-reducer) and provide the desired workability retention time (using a slump retention admixture, such as MasterSure® Z-60 admixture).

The adjustable, multi-component workability system of at least three types of dispersants, described above, each having a specific binding character, allows combinations to be selected that will provide at least one of: more efficient and faster concrete production, energy savings during the concrete manufacturing process, tailoring of dispersing speed, control of initial and final cementitious mixture consistency, and increased utilization of cement and SCM's.

One component of the multi-component workability system is the use of certain dispersants selected from those having extremely fast binding character and very short workability retention times described above as the batching and mixing efficiency admixture dispersants (hereafter also referred to as ultra-fast dispersants). These ultra-fast dispersants may be used in combination with typical, general use dispersants, such as mid and high range water reducers, and/or in combination with dispersants having long slump retention characteristics. The use of such ultra-fast dispersants improves concrete mixing efficiency, allows for increased production output of low water content cementitious mixtures, and may decrease the amount of energy required during the concrete mixing process.

In various embodiments, the general use cement dispersant may be at least one of traditional water reducers such as lignosulfonates, melamine sulfonate resins, sulfonated melamine formaldehyde condensates, salts of sulfonated melamine sulfonate condensates, beta naphthalene sulfonates, naphthalene sulfonate formaldehyde condensate resins, or salts of sulfonated naphthalene sulfonate condensates; or, conventional polycarboxylate, small molecule (oligomeric), phosphorylated aromatic or heteroaromatic polycondensate or polyphosphate ether (PAE, PPE), or polyaspartate, dispersants.

Nonlimiting examples of polycarboxylate dispersants can be found in U.S. Publication No. 2008/0300343 A1, U.S. Publication No. 2002/0019459 A1, U.S. Publication No. 2006/0247402 A1, U.S. Pat. No. 6,267,814, U.S. Pat. No. 6,290,770, U.S. Pat. No. 6,310,143, U.S. Pat. No. 6,187,841, U.S. Pat. No. 5,158,996, U.S. Pat. No. 6,008,275, U.S. Pat. No. 6,136,950, U.S. Pat. No. 6,284,867, U.S. Pat. No. 5,609,681, U.S. Pat. No. 5,494,516, U.S. Pat. No. 5,674,929, U.S. Pat. No. 5,660,626, U.S. Pat. No. 5,668,195, U.S. Pat. No. 5,661,206, U.S. Pat. No. 5,358,566, U.S. Pat. No. 5,162,402, U.S. Pat. No. 5,798,425, U.S. Pat. No. 5,612,396, U.S. Pat. No. 6,063,184, U.S. Pat. No. 5,912,284, U.S. Pat. No. 5,840,114, U.S. Pat. No. 5,753,744, U.S. Pat. No. 5,728,207, U.S. Pat. No. 5,725,657, U.S. Pat. No. 5,703,174, U.S. Pat. No. 5,665,158, U.S. Pat. No. 5,643,978, U.S. Pat. No. 5,633,298, U.S. Pat. No. 5,583,183, U.S. Pat. No. 6,777,517, U.S. Pat. No. 6,762,220, U.S. Pat. No. 5,798,425, and U.S. Pat. No. 5,393,343, which are all incorporated herein by reference, as if fully written out below. Nonlimiting examples of polyaspartate dispersants can be found in U.S. Pat. No. 6,429,266; U.S. Pat. No. 6,284,867; U.S. Pat. No. 6,136,950; and U.S. Pat. No. 5,908,885, which are all incorporated herein by reference, as if fully written out below. Examples of oligomeric dispersants can be found in U.S. Pat. No. 6,133,347; U.S. Pat. No. 6,451,881; U.S. Pat. No. 6,492,461; U.S. Pat. No. 6,861,459; and U.S. Pat. No. 6,908,955, which are all incorporated herein by reference, as if fully written out below. Nonlimiting examples of polyphosphate ether dispersants can be found in U.S. Publication No. 2011/0281975, incorporated herein by reference.

Conventional dispersants are static in their chemical structure over time in cementitious systems. Their performance is controlled by monomer molar ratio that is fixed within a polymer molecule. A water reducing effect or dispersing effect is observed upon dispersant adsorption onto the cement surface. As dispersant demand increases over time due to abrasion and hydration product formation, which creates more surface area, these conventional dispersants are unable to respond and workability is lost. As an example, conventional polycarboxylate dispersants may produce maximum concrete workability relatively quickly, but this workability is lost over time.

When concrete is fresh, it can be cast into a variety of shapes and sizes, and then shortly thereafter it hardens into a solid mass. That is, concrete transitions from a plastic, and many times flowable, consistency into a stiffer and finally hard element. This transition time, however, is variable due to a number of factors which, from the practical perspective, impacts the time that a concrete mixture maintains its fresh, workable consistency. Historically the industry has managed workability loss in several ways including; re-tempering (adding more water) to the concrete at the point of placement or at the casting site to restore workability, or by re-dosing with water reducing admixtures onsite, batching to a higher than desired slump (adding more high range water reducer) at the production site or by using retarding or hydration controlling admixtures. Each of these historical methods have both financial and performance costs associated with it. Addition of water leads to lower strength concrete and thus creates a need for mixes that are “over-designed” in the way of cement content. Site addition of high range water reducer requires truck mounted dispensers which are costly, difficult to maintain, and difficult to control.

In certain embodiments, non-ionic copolymer latent dispersants may be used in combination with the ultrafast dispersant, and at least one type of water reducing composition or general water reducing cement dispersant, to provide a combination of early enhanced batching and mixing efficiency, initial workability, water reduction and extended workability.

Initial slump is not affected by the addition of the non-ionic copolymer latent dispersants, but the addition of the non-ionic copolymers as compared to the use of general cement dispersants alone, such as polycarboxylate dispersants, improve slump retention. While the slump exhibited by polycarboxylate dispersant containing mixtures is initially high, slump steadily decreases over time.

The non-ionic copolymers are initially non-dispersing molecules, having low or no affinity to cement particles, and therefore do not contribute to achieving the cementitious composition's initial workability targets. The non-ionic copolymers remain in solution, however, acting as a reservoir of potential dispersant polymer for future use. Over time, as dispersant demand increases, due either in part to the exhaustion of conventional dispersant as discussed above, or partly or wholly to mix design factors, these molecules undergo base-promoted hydrolysis reactions along the polymer backbone which generate active binding sites both to initialize and to increase the polymer's binding affinity, resulting in the in-situ generation of “active” dispersant polymer over time, to extend slump and workability of the composition. Non-limiting illustrative examples of non-ionic copolymer latent dispersants are disclosed in U.S. Pat. No. 8,519,029, which is incorporated herein by reference, as if fully written out below.

The use of nonionic copolymer latent dispersants in combination with a traditional dispersant or a conventional polycarboxylate dispersant in cementitious compositions exhibit superior workability retention without retardation, minimize the need for slump adjustment during production and at the jobsite, minimize mixture over-design requirements, reduce re-dosing of high-range water-reducers at the jobsite, and provide high flowability and increased stability and durability.

Another type of latent dispersant includes dynamic polymers, which contain some cement-binding sites, but which have a portion of their binding sites blocked with groups that are stable to storage and formulation conditions. These latent binding sites are triggered to be de-protected when the polymer comes into the highly alkaline environment that is found in cementitious compositions.

A non-limiting illustrative example includes dynamic polycarboxylate copolymer comprising residues of unsaturated mono- or di-carboxylic acids, at least one ethylenically unsaturated alkenyl ether or carboxylic acid ester having a C₂₋₄ oxyalkylene chain, and an ethylenically unsaturated monomer comprising a moiety hydrolysable in the cementitious composition, wherein the ethylenically unsaturated monomer residue when hydrolyzed comprises an active binding site for a component of the cementitious composition. The dynamic polymer may include monomer residues having other linkages such as amides. In certain embodiments, the dynamic polymer may include monomer residues derived from other non-hydrolysable ethylenically unsaturated monomers, such as styrene, ethylene, propylene, isobutene, alpha-methyl styrene, methyl vinyl ether, and the like. Non-limiting illustrative examples of dynamic copolymer latent dispersants are disclosed in U.S. Patent Publication number 2012/0046392 A9, which is incorporated herein by reference, as if fully written out below.

The use of the latent dispersant copolymers as a dispersant reservoir in cementitious compositions provides extended workability retention beyond what has previously been achievable with static dispersant polymers, alleviating the need to re-temper, and allowing producers to reduce cement content (and thus cost) in their mix designs, as well as allowing for better control over longer-term concrete workability, more uniformity and tighter quality control for concrete producers.

The combination of the ultrafast dispersant; a traditional water reducing dispersant or a conventional polycarboxylate, small molecule oligomeric, polyphosphate or polyaspartate dispersant; and a slump retention copolymer provides enhanced batching and mixing efficiency, initial slump and the ability to tailor workability of a cementitious mixture for a specific application. This permits control over the concrete cementitious mixture consistency from batching until placement. FIG. 2 is a graph demonstrating how the fluidity of a concrete cementitious mixture can be controlled during mixing, transport and placement, at a desired level shown by the arrowed line, through the averaging effect of the waxing and waning activities of an ultrafast dispersant A, a traditional water reducer or a conventional dispersant B, and a slump retention copolymer C.

The three components of the multicomponent admixture can be added to the cementitious mixture simultaneously in one formulation, or in separate formulations substantially contemporaneously, or separately at different times.

Therefore, a concrete production method is provided for controlling consistency of a concrete cementitious mixture from batching to placement comprising adding to the cementitious mixture:

a) prior to or during the batching and/or mixing process, an ultrafast dispersant admixture comprising dispersant molecules having an ionic moiety or multiple ionic moieties that bind very rapidly with cement particles, and optionally one or more nonionic dispersing moiety(ies), that provide a dispersing effect and initial slump during the mixing process, wherein the dispersing effect of the admixture diminishes rapidly;

b) optionally at least one general water reducing cement dispersant for providing workability to the cementious mixture; and

c) optionally at least one latent dispersant copolymer having moieties capable of undergoing base-promoted hydrolysis in the cementitious mixture to generate active cement binding sites over time, to extend slump and workability of the cementitious mixture.

The subject batching and mixing efficiency admixture comprising the ultrafast dispersant may be added to the cementitious mixture initially (before or during mixing) in a dosage range of about 0.01 to about 3 weight percent based upon the weight of the cementitious materials (hydraulic binder and SCM), and in certain embodiments, in a dosage range of about 0.01 to about 2 weight percent ultrafast dispersant.

In certain embodiments, the ultrafast dispersant admixture may be additionally added at the job site to assist in mixing and/or placement of the concrete cementitious mixture.

In other embodiments, the ultrafast dispersant admixture may be added in a proportion to generate a low slump concrete cementitious mixture, and at least one latent copolymer may added to maintain the low slump for placement of the concrete cementitious mixture.

In the subject concrete production method, a multicomponent workability admixture, may be used, in which the ultrafast dispersant may be added to the cementitious mixture in the proportions set out above; the general water reducing cement dispersant (traditional water reducing dispersant or conventional polycarboxylate, small molecule (oligomeric), phosphorylated aromatic or heteroaromatic polycondensate or polyphosphate ether (PAE, PPE), or polyaspartate dispersant) may be added to the cementitious mixture with the initial batch water or as a delayed addition to the cementitious mixture, in a dosage range of 0 to about 3 weight percent based on the weight of cementitious materials, and in certain embodiments, 0 to about 1 weight percent; and, the latent dispersant copolymer can be added to the cementitious mixture with the initial batch water or as a delayed addition, in a dosage range of 0 to about 3 weight percent based on the weight of cementitious materials, and in certain embodiments, 0 to about 1 weight percent.

In certain embodiments, the general water reducing cement dispersant may be added to the cementitious mixture with the initial batch water or as a delayed addition to the cementitious mixture, in a dosage range of about 0.01 to about 3 weight percent based on the weight of cementitious materials, and in certain embodiments, about 0.02 to about 1 weight percent; and, a slump retention copolymer can be added to the cementitious mixture with the initial batch water or as a delayed addition, in a dosage range of about 0.01 to about 3 weight percent based on the weight of cementitious materials, and in certain embodiments, about 0.02 to about 1 weight percent.

The use of the MasterSure® Z 60 slump retention admixture allows for flexible levels of workability retention while minimizing or eliminating the costs associated with the historical methods mentioned above, and may maintain workability of concrete mixtures without retarding set or strength development for up to 3 hours. By eliminating the need for re-tempering, re-dosing or using retarding admixtures, the consistency of slump, air content and compressive strength is improved for cementitious compositions. Also, valuable truck time is saved, since each re-tempering or re-dosing activity requires approximately 10 minutes to complete. FIG. 3 shows the flexible performance of the MasterSure Z 60 admixture. Shown in this graph is the workability retention of 3 concrete batches, each using the same mixture proportions and raw materials. The three batches were run at 0, 3 or 6 oz/cwt (0, 195 or 390 m1/100 kg) of MasterSure Z 60 admixture. The weight percent of slump retention polymer added, based on weight of cement in these three concrete batches, was 0%, about 0.04%, and about 0.08%.

In an embodiment of the multicomponent workability admixture, the ultrafast dispersant may be added to the cementitious mixture (initially or after mixing commences) in the proportions set out above; the general water reducing cement dispersant (traditional water reducing dispersant, or conventional polycarboxylate, small molecule (oligomeric), phosphorylated aromatic or heteroaromatic polycondensate or polyphosphate ether (PAE, PPE), or polyaspartate dispersant) can be added to the cementitious mixture with the initial batch water or as a delayed addition to the cementitious mixture, in a dosage range of about 0.01 to about 1 weight percent based on the weight of cementitious materials, and in certain embodiments, about 0.02 to about 0.5 weight percent; and the dynamic latent dispersant copolymer can be added to the cementitious mixture with the initial batch water or as a delayed addition, in a dosage range of about 0.01 to about 1 weight percent based on the weight of cementitious materials, and in certain embodiments, about 0.02 to about 0.5 weight percent.

By incorporating the subject batching and mixing efficiency admixture (ultrafast dispersant), a water reducer (general water reducing cement dispersant) and a latent dispersant copolymer (for example a slump retention admixture, such as MasterSure® Z 60), into daily production, steps 3-4, 6 and 8 in the production process discussed above can be optimized.

Step 3—Mixing time can be shortened because of the batching and mixing efficiency admixture (ultrafast dispersant) rapid dispersing effect. This is particularly helpful in a high production wet batch plant. This can also eliminate the potential for the batch plant operator to make unnecessary admixture or water adjustments since the mixture will achieve its ultimate slump more rapidly. This will result in more consistent concrete performance.

Step 4—Because the batching and mixing efficiency admixture (ultrafast dispersant) in combination with the mid or high range water reducer achieves their target slump more rapidly, the need for the driver to monitor and adjust loads prior to leaving the yard will be reduced. Truck time in the yard, prior to leaving, will be minimized and some variability from the production process will be removed, resulting in more consistent concrete performance and faster truck turnaround.

Step 6—Through the use of a slump retention admixture, such as MasterSure® Z 60, concrete mixtures will not lose workability on their way to the jobsite. This will significantly reduce, or in many cases eliminate, the need for jobsite adjustments impacting both truck time, quality control personnel time and mixture cost. The consistency of concrete performance will also be improved.

Step 8—If concrete maintains desired workability (highly flowable), the discharge rate is increased.

Potential applications and benefits of the subject batching and mixing efficiency admixture and method include at least one of:

Faster turn-around of mixing trucks or increased production rate at a central mix plant.

More consistent air generation due to higher or faster plasticity of the mix during the mix cycle.

Improved production of more sustainable concrete mixtures based on high powder, low water contents.

Initial mixing at much higher fluidity than current practice. This allows for changes in mixture proportions that currently cannot be effectively mixed at stiffer consistencies, such as for example, allowing for high fiber loading in low slump paving mixes.

Allowing for higher levels of water reduction without necessarily having a fluid or more fluid ending consistency.

More efficient use of cement by providing more complete dispersion of particles, thereby providing higher strength or allowing for high levels of SCM's.

Lowered mixture viscosity by providing more complete dispersion of powder fraction of a mixture.

Improved pigment efficiency due to increased dispersion of the mixture powder fraction (manufactured concrete products).

Reduction of cement packing during the batching process.

Use with mobile mixers that currently use in-efficient auger type mixers.

Allowing for jobsite addition to create “self consolidating concrete”-like flowable consistency that lasts only during placement.

A reduction of electrical energy required to complete the mixing cycle. Mixer amperage is frequently monitored for central mixers. By increasing the speed with which a mixture achieves fluidity, either the length of required mixing time or a lower amperage draw during the mixing process can be realized. This can result in energy savings.

Although the embodiments have been described in detail through the above description and the preceding examples, these examples are for the purpose of illustration only and it is understood that variations and modifications can be made by one skilled in the art without departing from the spirit and the scope of the disclosure. It should be understood that the embodiments described above are not only in the alternative, but can be combined.

We claim:

1. A method of enhancing efficiency of a batching and/or mixing process for a concrete cementitious composition, comprising adding to the cementitious composition prior to or during the batching and/or mixing process, an admixture comprising dispersant molecules having an ionic moiety or multiple ionic moieties that bind very rapidly with cement particles, and optionally one or more nonionic dispersing moiety(ies), that provide a dispersing effect and initial slump during the mixing process, wherein the dispersing effect of the admixture diminishes rapidly.

2. The method of claim 1 wherein the dispersing effect of the admixture diminishes within about 20 minutes, optionally within about 10 minutes or further optionally within about 5 minutes, of achieving a homogeneous mixture.

3. A multi-component admixture system comprising:
a) at least one ultrafast dispersant having an ionic moiety or multiple ionic moieties that bind very rapidly with cement particles, that provide a dispersing effect and initial slump to a concrete cementitious composition optionally during mixing, wherein the dispersing effect diminishes rapidly;
b) at least one general water reducing cement dispersant for providing workability to the cementious composition; and,
c) at least one latent dispersant copolymer having moieties capable of undergoing base-promoted hydrolysis in the cementitious composition to generate active cement binding sites over time, to extend slump and workability of the cementitious composition.

4. The multi-component admixture system of claim 3, wherein the ultrafast dispersant is selected from:
an extremely fast cement-binding polycarboxylate, having a high ratio of anionic binding residues to (poly)ether side chain terminated residues, optionally greater than or equal to about 10:1, or greater than or equal to about 7:1, or greater than or equal to about 5:1, or greater than or equal to 3:1; and,
a homopolymer or copolymer of acrylic acid, methacrylic acid, maleic acid, or mixtures thereof, optionally containing residues of units not having a polyether side chain, optionally acrylic acid ester and/or maleic acid ester, and optionally being sulfated or sulfonated and/or phosphated or phosphonated.

5. The multi-component admixture system of claim 3, wherein the general water reducing cement dispersant is selected from at least one of lignosulfonate, melamine sulfonate resin, sulfonated melamine formaldehyde condensate, salts of sulfonated melamine sulfonate condensate, beta naphthalene sulfonate, naphthalene sulfonate formaldehyde condensate resin, or salts of sulfonated naphthalene sulfonate condensate.

6. The multi-component admixture system of claim 3, wherein the general water reducing cement dispersant is a conventional polycarboxylate dispersant, small molecule oligomeric dispersant, phosphorylated aromatic or heteroaromatic polycondensate or polyphosphate ether dispersant or polyaspartate dispersant.

7. The multi-component admixture system of claim 3, wherein the latent dispersant copolymer is a non-ionic copolymer.

8. The multi-component admixture system of claim 3, wherein the latent dispersant copolymer is a dynamic polycarboxylate copolymer.

9. A concrete production method for controlling consistency of a concrete cementitious mixture from batching to placement comprising adding to the cementitious mixture:
a) prior to or during the batching and/or mixing process, an ultrafast dispersant admixture comprising dispersant molecules having an ionic moiety or multiple ionic moieties that bind very rapidly with cement particles, and optionally one or more nonionic dispersing moiety(ies), that provide a dispersing effect and initial slump during the mixing process, wherein the dispersing effect of the admixture diminishes rapidly;
b) optionally at least one general water reducing cement dispersant for providing workability to the cementious mixture; and
c) optionally at least one latent dispersant copolymer having moieties capable of undergoing base-promoted hydrolysis in the cementitious mixture to generate active cement binding sites over time, to extend slump and workability of the cementitious mixture.

10. The method of claim 9, wherein the ultrafast dispersant admixture a) is additionally added at the job site to assist in mixing and/or placement of the concrete cementitious mixture.

11. The method of claim 9, wherein the ultrafast dispersant admixture a) is added in a proportion to generate a low slump concrete cementitious mixture, and the at least one latent copolymer c) is added to maintain the low slump for placement of the concrete cementitious mixture.

12. The method of claim 9, wherein the ultrafast dispersant is added to the cementitious mixture initially in a dosage range of about 0.01 to about 3 weight percent based upon the weight of cementitious material, optionally in a dosage range of about 0.01 to about 2 weight percent; the general water reducing cement dispersant is added to the cementitious mixture with the initial batch water or as a delayed addition to the cementitious mixture, in a dosage range of 0 to about 3 weight percent based on the weight of cementitious material, optionally 0 to about 1 weight percent; and, the latent dispersant copolymer is added to the cementitious mixture with the initial batch water or as a delayed addition, in a dosage range of 0 to about 3 weight percent based on the weight of cementitious material, optionally 0 to about 1 weight percent.

13. The method of claim 12 wherein the general water reducing cement dispersant is added to the cementitious mixture in a dosage range of about 0.01 to about 3 weight percent based on the weight of cementitious materials, optionally about 0.02 to about 1 weight percent; and, a slump retention latent dispersant copolymer is added to the cementitious mixture in a dosage range of about 0.01 to about 3 weight percent based on the weight of cementitious materials, optionally about 0.02 to about 1 weight percent.

14. The method of claim 12 wherein the general water reducing cement dispersant is added to the cementitious mixture in a dosage range of about 0.01 to about 1 weight percent based on the weight of cementitious materials, optionally about 0.02 to about 0.5 weight percent; and a dynamic latent dispersant copolymer is added to the cementitious mixture in a dosage range of about 0.01 to about 1 weight percent dynamic copolymer based on the weight of cementitious materials, optionally, about 0.02 to about 0.5 weight percent.
